(19) United States
(12) Patent Application Publication
(10) Pub. No.: US 2011/0036244 A1
(43) Pub. Date: Feb. 17, 2011

(54) ASSEMBLY FOR AUTOMATIC FRESH BREWING OF HOT BEVERAGE AND DISPENSING THEREOF

(76) Inventors: Ashim Chatterjee, Kolkata (IN); George Kandappali Mani, Rondicherry (IN); Munusamy Balasubramaniam, Chennai (IN)

Correspondence Address: Progressive IP Solutions, 32 Pershing Street, Staten Island, NY, 10305, US

(21) Appl. No.: 12/988,816

(22) PCT Filed: Dec. 29, 2008
(86) PCT No.: PCT/IN08/00871

§ 371 Date: Oct. 21, 2010

(30) Foreign Application Priority Data
Apr. 28, 2008 (IN) 780/KOL/2008

(51) Int. Cl. A47J 31/40

(52) U.S. Cl. 99/283

(57) ABSTRACT

This invention relates to an assembly for automatic fresh brewing of hot beverage and dispensing thereof which uses single serving pods (18) stacked in plurality of static vertically extending chutes (36, 38). The assembly dispenses each individual serving of fresh hot beverage with consistent taste and flavor, within a short time and customized to a consumer's preference like ‘strong’, ‘light’, ‘with milk’, ‘without milk’, etc. The assembly includes a water heating sub-assembly (100) for hot pressurized water for the brewing purpose; a pod-conveyor sub-assembly (200) for automatically conveying the pod (18) from the chutes (36, 38) to the brewer sub-assembly (400) and disposing off the used pod (18); a milk-input sub-assembly (300) for dispensing heated milk directly to a dispensing cup (19), when desired by the consumer; a brewer sub-assembly (400) for brewing of the brewing, infusible or other material (111) contained in pod (18) to produce fresh hot beverage; an electronic processor (500); an electronic control panel (600) with plurality of switches (610), each switch (610) corresponding to a preference of a consumer; a water reservoir (2); and compressed air storage tank (110) containing air compressed by an air compressor (120); and air solenoid valves (83, 115). The assembly is capable of brewing wide variety of brewing, infusible or other materials including, but without implying any limitation thereto, tea, coffee, material of plant origin such as floral pieces like Jasmine flowers, vegetable pieces like carrots, onions, material of animal origin such as honey or any other suitable beverage powders or materials which can be placed in the single serving pod (18) of the assembly.

### CROSS-REFERENCE TO RELATED APPLICATIONS

This application is a National Phase Application of PCT International Application No. PCT/IN2008/000871, entitled “AN ASSEMBLY FOR AUTOMATIC FRESH BREWING OF HOT BEVERAGE AND DISPENSING THEREOF”, International Filing Date Dec. 29, 2008, published on Dec. 30, 2009 as International Publication Number WO 2009/133569; which in turn claims priority from Indian Patent Application No. 780/KOL/2008, filed Apr. 28, 2008.

### TECHNICAL FIELD

This invention relates to an assembly for automatic fresh brewing of hot beverage and dispensing thereof wherein when an operating command is given by an operator on an electronic control panel, the assembly in conjunction with an electronic processor provided therein, automatically brews and dispenses customized hot beverage using a single serving pod within a short time, as per input command signals relating to the consumer's preference like ‘strong’, ‘light’, ‘with milk’, ‘without milk’, etc. selectable on the electronic control panel. A wide variety of hot brewed beverage, hot water infusion or other hot beverages may be prepared with the assembly by placing different brewing, infusible or other materials in the single serving pod of the present invention. The brewing, infusible or other materials which can be used in the pod include, without implying any limitation thereto, materials such as tea, coffee, materials of plant origin such as floral pieces like Jasmine flowers, vegetable pieces like carrots and onions, materials of animal origin such as honey or any other suitable beverage powder or material that can be used in the pod.

The assembly is capable of brewing each individual single serving of hot beverage with perfect consistency and with high speed, the taste and flavor being like the beverage that has been manually prepared at that instant of time and at that location. The assembly is, specifically, but without implying any limitation thereto, useful for meeting the bulk demand for a brewed hot beverage, in a time-efficient manner, in offices, ceremonial functions, public meetings, etc.

### BACKGROUND OF THE INVENTION

Several hot beverage-dispensing machines known in the art use a pre-mix powder to provide a pre-mix based beverage to the consumer. The pre-mix powder used in such dispensing machines contains either tea or coffee powder mixed with sugar, milk powder, etc. Such pre-mix powder is combined with hot water dispensed from the machine, and the hot beverage thus prepared is served to the consumer.

A drawback of the above type of dispensing machine is that the pre-mix based hot beverage prepared by just mixing hot water from the dispensing machine with a premix powder of tea or coffee is inferior in taste and flavor as compared to that of a freshly prepared hot beverage of the same type. For example, taste, aroma and flavor of the coffee prepared using a pre-mix powder would not match with that of a coffee that has been freshly prepared from coffee beans. A consumer generally prefers a freshly brewed hot beverage like tea or coffee, customized to his preference of strength and taste.

Another drawback of the above type of dispensing machine is that any quality of pre-mix powder may be mixed with hot water to prepare final beverage. The quality of final beverage thus prepared depends upon the quality of the pre-mix powder used. Any inferior/spurious quality pre-mix powder used in the preparation of the hot beverage would provide poor quality beverage lacking in taste, aroma and flavor. The machines of this type have no inherent means to prevent the use of such inferior/spurious quality pre-mix powders.

Further drawback of the above type of dispensing machines is that the beverage prepared may lack consistency due to variation in dosing of the pre-mix powder.

An ‘Espresso Brewing Device’ reported in U.S. Pat. No. 6,820,535 comprises a rotatable magazine table equipped with five magazine tubes arranged along the circumference of the said table, each magazine holding a stack of single-serving capsules with their bottom membrane facing downwards and each magazine tube storing a different type of coffee/tea capsules. Each magazine tube has an opening through which the lowest capsule in the magazine tube is pushed out by a capsule gripper. Means (like sensors or scanners, etc.) are provided for setting the position of the magazine table. The capsule conveying device comprises a motor with a drive mechanism equipped with a driving disc and a driving stud. An actuating lever, swivel-mounted on a rotation bearing, ejects out a single serving capsule and inserts it into the brewing unit.

Once, the single serving capsule is inside the brewing unit, the spindle piston gets lowered into the brewing position by means of a spindle piston drive which includes a driving motor, a drive mechanism and a ‘capsule piercer’ provided in the upper part of the brewing chamber insert. The upper surface of the single serving capsule is pierced by the capsule piercer that points downwards and contains brewing water supply channels located inside therein. The brewing water flows into the single serving capsule at a pressure of 10 to 15 bars and at a temperature of approx. 95° C. When an inner pressure of 6 bars is reached within the capsule, the membrane forming the base of the capsule is pressed against the pyramid-shaped profile of a plate and the membrane gets pierced. The brew flows out through draining holes on the plate and the outlet opening of the brewing unit.

A drawback of the above device is that it is a complex design requiring multiple piercing means. One side of the single serving capsule containing brewing substance is pierced by a capsule-piercer for entry of hot pressurized water into the capsule. The other side of the capsule is pierced by a plate having multiple pyramid-profiled points for allowing the brewed beverage to flow out.

Another drawback of the above device is that there is a complex mechanism for conveying of the capsule from the magazine tube to the brewing unit which involves an actuating lever, drive motor, driving disc, driving stud, capsule gripper, and the actuating lever being swivel mounted on a rotation bearing. Similarly, the brewing unit also involves complex mechanism involving spindle piston drive consisting of a drive motor, drive mechanism, drive pin engaging with an outer gear tooth system of a spindle piston drive gear equipped with inner gear tooth system, and so on. The complexity of the machine and relatively more number of moving components may cause higher operating and maintenance costs, in addition to being more expensive to manufacture.

Still another disadvantage of the above brewing machine is that the outflow of the brewed liquid occurs through the holes in membrane of the capsule, which are caused due to piercing by a pyramid-profiled plate. These holes may allow fine tea/coffee particles to pass through along with the brewed liquid, thereby adversely affecting the quality of the hot beverage dispensed into the dispensing cup or blocking the exit tubes that convey the brewed liquid out of the brewing unit.

Further drawback of the above assembly is that the inflow of hot water takes place from one side and outflow occurs from other side of the capsule with the result that the brewing of the brewing material contained in the capsule is not thorough as some of the brewing material particles may not be brewed. Additionally, the arrangement of inflow of water from one side and outflow from the other side of capsule results in the design of the assembly being very complex and the brewer unit becoming bulky.

Another prior art dispensing machine is reported in the PCT application No. PCT/US2005/031604 titled as “Coffee and tea dispenser with removable pod turret wheel”. The invention comprises a turret assembly, a water control system controlling the flow of water in the beverage dispenser, a heat exchanger placed in water reservoir heated by a heat source, an injector assembly, a loading assembly including a pod carousel with pod compartments containing pod cartridges and an electronic control. The turret assembly includes a turret frame, a turret plate and a turret shaft connecting the turret plate to the turret frame for rotation therewith, by a turret motor. The water control system in the above device includes a water source like a tap, water lines, a secondary water source, an extraction pump to pressurize the water and a flow sensor. An electronic control controls the operation of extraction pump, flow sensor, heat source, solenoid valve, etc. The injector assembly includes an injection nozzle, injector head movable vertically via a cam system, a drive motor and an eccentric cam. When eccentric cam rotates, an idler wheel pushes a support plate downward such that the injector head comes into contact with the pod cartridge. The electronic control then reverses the cam system and the injector head returns to its original position.

A drawback of the above apparatus is that it is complex and cumbersome as compared to the machine of the present invention as the above apparatus requires a hot water reservoir of 7 to 19 liters capacity, a heat exchanger positioned within the said reservoir, and a network of water lines, besides, multiple electric, electronic and mechanical components as compared to the assembly of the present invention.

Another drawback of the above apparatus is that the pod used in the apparatus is relatively complex and therefore may be more complex to manufacture and relatively more expensive as compared to the pod of simple design used in the present invention. In the above apparatus, the pod has thermoplastic insert with a plurality of apertures provided at the top of the pod, the insert being further covered with a foil. The bottom of the pod is made of a filter paper or a foil with a scored area, which becomes detached when the hot pressurized water gets injected into the pod. The hot pressurized water enters into the pod through the apertures in the insert and flows out through the scored area. The complexity and higher cost of the said pod result in increase of the final cost per cup of beverage, to the consumers.

Further, in the above apparatus, the water flows into the pod from the top and flows out through the bottom, which necessitates provision of filter paper with apertures at one side and means for allowing the flow out of water from the other side.

Still further drawback of the above apparatus is that the apparatus heats the water in the heat exchangers and thus heated water in turn heats the water flowing in the pipe placed inside the heat exchanger. The above device therefore, is not energy-efficient as compared to the assembly of the present invention wherein the heat exchanger is avoided and the hot water required for brewing is directly heated inside a sealed boiler tank by a heating element.

Yet further drawback of the above apparatus is that the foil on the top side of the capsule is pierced by a separate injector assembly with complex configuration of an injection nozzle, injector head, a cam system drive motor, cam system, an eccentric cam, drive belt, an idler wheel support plate, injector frame and a number of guide wheels. Whereas in the present invention, the injection nozzle remains fixed to the base of the brewer and the plunger of the brewer sub-assembly presses the pod with its porous membrane facing downwards, against the conical tip of the injection nozzle leading to the puncturing of the porous membrane, thereby allowing the hot pressurized water from the boiler tank to flow into the pod through the interior of the injection nozzle.

### SUMMARY OF THE INVENTION

The assembly of the present invention is capable of automatic fresh brewing of hot beverage and dispensing thereof using a single serving pod within short time of 15 to 20 seconds. A uniquely designed pod-conveyor having an inward contour at its forward end and rotatable by an electric motor is capable of performing multiple functions by its rotational movement in a substantially horizontal plane and by holding the pod firmly within its inward contour at its forward end which is aligned with contour of the pod. The functions performed by the pod-conveyor include conveying the pod from a chute to brewer sub-assembly, precisely positioning it on the filter disc in the brewer sub-assembly without any provision of a guide channel having been provided in the assembly and then disposing off the used pod into the disposal bin. This greatly simplifies the design and minimizes mechanical components.

The assembly is user friendly and easy to operate, as the operator/consumer has just to indicate his preference by selecting the switch on the electronic control panel corresponding to the consumer's preference for the type of beverage like ‘strong’, ‘light’, ‘with milk’, ‘without milk’, etc. The signal is conveyed by the electronic control panel to the electronic processor, which triggers the electrical components of other sub-assemblies in the required sequence and the assembly automatically performs all the necessary operations resulting in dispensing of ready-to-drink and customized hot beverage in a dispensing cup. The automatic operations of the assembly extend from conveying & positioning of the pod into the brewer sub-assembly, injection of hot pressurized water into the pod containing brewing material, disposal of used pod into the disposal bin etc. to drawing of milk from a liquid milk container, heating milk in a milk-mixing chamber by steam from water-heating sub-assembly and the dispensing of thus heated milk directly into the dispensing cup when the milk is dosed with respect to the beverage. Each individual serving by the assembly is consistent in taste and flavor.

The assembly includes a sensor placed underneath each chute. The sensor placed beneath the first chute which is in closer proximity to the brewer sub-assembly detects the availability of single serving pods in this chute. When it detects that this chute is empty, it gives signal to the electronic processor, which causes the pod-conveyor to move behind the second chute and convey pods therefrom to the brewer sub-assembly. A sensor placed beneath the second chute senses when this chute is empty and sends a signal to the electronic processor, which in turn causes the pod-conveyor to move to rest or start position behind first chute, causes halting till refill of the empty chutes with fresh pods, of the brewing process in the brewing sub-assembly by switching off power supply to air solenoid valve and also simultaneously sends a signal on the electronic display panel providing message to the operator to refill the empty chutes with fresh pods. Such provision of sensors enhances the capability of the assembly to operate with a substantially higher stock of pods stacked in plurality of static chutes to meet bulk demands like in offices, etc. This also eliminates the need for separate motor and associated mechanism for rotation of the base plate on which pod chutes are fitted, as is known in the art.

A filter disc with pores less than 250 microns and the porous membrane used to cover and seal the brewing material contained in the single serving pods prevent miniscule brewing material particles from the pod to flow out along with the brewed liquid into the dispensing cup thereby ensuring high quality of brewed liquid.

The sealed boiler tank stores water at high temperatures without loss of dissolved oxygen contained within the water, which enhances the quality of beverage especially tea. The use of a sealed boiler tank also makes the assembly energy-efficient. The brewer sub-assembly used in the present invention is substantially airtight during brewing which prevents the escape of aroma and other volatile chemicals. Such chemicals which remain in the brewed liquid further add to the flavor, taste and aroma of the dispensed hot beverage.

In an embodiment, the air, compressed by an air compressor and pumped and stored in an air storage tank, operates a pneumatic cylinder with the help of an air solenoid valve, thereby the pneumatic cylinder speedily moves the brewer plunger up and down into the brewer chamber, during the brewing process.

The single serving pods used in the assembly have simple structure with no mechanism whatsoever embodied in the interior of the pods, thereby making the single serving pods easy to manufacture at low cost, thus making the cost per dispensed cup also low. The assembly is capable of brewing a wide variety of brewing, infusible and other materials that can be placed in these pods. Such brewing, infusible or other materials which can be used in the pod include, without implying any limitation thereto, materials such as tea, coffee, materials of plant origin such as floral pieces like Jasmine flowers, vegetable pieces like carrots and onions, materials of animal origin such as honey or any other suitable beverage powder or material that can be used in the pod.

The brewer sub-assembly of the present invention uses an injection nozzle with a conical tip which is capable of performing both the functions of puncturing the porous membrane of the single serving pod as well as injecting the hot pressurized water from the sealed boiler tank into the interior of the pod resulting in brewing of the brewing material contained within the pod. The assembly ensures hygiene by having fully automatic operations with no human intervention and automatic spillage-free disposal of used pods into the disposal bin.

In view above, therefore, an object of the present invention is to provide an assembly, which is capable of automatic fresh brewing of hot beverage, and dispensing thereof wherein the brewing material is contained in a single serving pod and the freshly brewed liquid is automatically dispensed directly into a dispensing cup.

Another object of the present invention is to provide an assembly which brews and dispenses each individual serving with perfect consistency in taste and flavor and like the beverage manually freshly prepared at that time and at that location.

Still another object of the present invention is to provide an assembly which can enable preparation of a wide variety of hot brewed beverages, hot water infusions or other hot beverages depending upon the brewing material, infusible material or other material contained in the single serving pod which include, without implying any limitation thereto, materials such as tea, coffee, materials of plant origin such as floral pieces like jasmine flowers, vegetable pieces like carrots and onions, materials of animal origin such as honey or any other suitable beverage powder or material that can be used in the pod.

Yet another object of the present invention is to provide an assembly which enables the operator to prepare the beverages of different strengths customized to the consumer requirement like ‘strong’, ‘light’, ‘with milk’ and ‘without milk’, without any manual manipulation of the quantity of the brewing material or temperature control.

Still another object of the present invention is to provide an assembly which enables brewing with relatively higher speed by using optimized temperature, pressure and rate of flow of water into the brewing pod. This makes the assembly specifically suitable for brewing large number of cups in a short period, which is required in places like offices and commercial establishments.

Further object of the present invention is to provide an assembly wherein all brewing and dispensing operations are automatic. The automatic operations include conveying & positioning of the single serving pod into the brewer, brewing of brewing material in the pod by hot pressurized water from sealed boiler tank injected through an injection nozzle, dispensing of the brewed liquid into a dispensing cup, disposal of used pods into a disposal bin, and adding of heated milk into the beverage cup when the milk is dosed with respect to the beverage. The consumer/operator has only to activate a switch on the electronic control panel as per his choice of type of hot beverage and the assembly performs all the above operations automatically and dispenses customized hot beverage. This makes the assembly user friendly and easy to operate even by a lay person.

Still further object of the present invention is to provide an assembly wherein just one means namely injection nozzle performs the multiple functions of puncturing the porous membrane of the single serving pod as well as injecting of hot pressurized water for brewing into the pod thereby simplifying the complexity of the brewer design.

Even further object of the present invention is to provide an assembly wherein the injection nozzle penetrates through the porous membrane up to the top end of the pod kept in inverted position causing injected water to splash back thereby resulting in the uniform spreading of hot pressurized water inside the pod and brewing every minute particle of the brewing material contained in the pod.

Still further object of the present invention is to provide an assembly which uses low cost single serving pods of simple structure as compared to some of the costly pods of complex structure known in the art (which incorporate puncturing or injecting means) and therefore the single serving pods of the present invention are easy to manufacture and are cost-effective thereby making the cost per cup viable for the consumers in the developing markets.

Yet further object of the present invention is to provide an assembly which uses simple and static chutes containing stack of inverted single serving pods thereby minimizing the precision components required for alignment of pods within the chutes and thus also reducing the maintenance.

Even further object of the present invention is to provide an assembly which is hygienic as the assembly does not require human intervention during the entire brewing process and the assembly incorporates an automatic disposal mechanism which ensures spillage-free disposal of the used pods into the disposal bin.

Yet further object of the present invention is to provide an assembly wherein a non-corrosive and food grade filter disc having fine pores of up to 250 microns together with the porous membrane used on the top of the single serving pod prevents miniscule particles of brewing material from flowing into the dispensing cup along with the brewed liquid thereby ensuring fine quality of dispensed hot beverage.

Still further object of the present invention is to provide an assembly which uses completely sealed boiler tank that stores water at high temperatures without loss of dissolved oxygen contained within the water, which enhances the taste and quality of brewed beverage especially tea.

Even further object of the present invention is to provide an assembly wherein the brewer sub-assembly is substantially airtight during brewing which prevents the escape of the volatile chemicals which contribute to the aroma, flavor and taste of the prepared fresh hot beverage. These volatile chemicals which remain in the brewed liquid enhance the flavor, taste and aroma of the dispensed hot beverage.

Yet further object of the present invention is to provide an assembly which uses completely sealed boiler tank, which makes the assembly energy-efficient.

### BRIEF DESCRIPTION OF DRAWINGS

The invention will now be illustrated with Figures, which are intended to illustrate one of the embodiment in which the present invention may be practiced. The accompanying figures are not intended to be taken restrictively to imply any limitation on the scope of the present invention. It is to be noted that the invention is not deemed limited to the exact construction shown by these Figures. Any modifications, adaptations, equivalent changes by the persons skilled in the art employing the principles and functional features as embodied in the present invention are intended to be within the scope of the present invention. In the accompanying Figures:

FIG. 1: shows a plan view of the exterior of the assembly of the present invention.

FIG. 2: shows an overall assembly of the present invention housed inside housing.

FIG. 3: shows the water heating sub-assembly.

FIG. 4: shows the pod-conveyor sub-assembly in conjunction with brewer sub-assembly.

FIG. 5: shows the exploded view of the pod-conveyor sub-assembly in conjunction with brewer sub-assembly.

FIG. 6(a): shows the pod-conveyor in the rest or start position behind the first chute.

FIG. 6(b): shows the alignment of the inward contour of the pod-conveyor with the pod and conveying and precisely positioning the pod in the brewer sub-assembly.

FIG. 6(c): shows the pod-conveyor between the first chute and the brewer sub-assembly waiting for the completion of the brewing.

FIG. 6(d): shows the pod-conveyor with inward contour aligned with the used pod at the instant of its disposal into the disposal bin.

FIG. 7: shows the exploded view of the brewer sub-assembly.

FIG. 8: shows the milk input sub-assembly.

FIG. 9: shows the schematic connections of the electronic processor.

FIG. 10 a, b, c: show the construction of three illustrative embodiments of the single serving pod containing brewing material.

### DESCRIPTION OF INVENTION w.r.t. DRAWINGS

According to the present invention, there is provided an assembly for automatic fresh brewing of hot beverage and dispensing thereof, which automatically brews the brewing material contained in a single serving pod and dispenses the hot beverage within a short time of 15 to 20 seconds. The individual servings of freshly brewed hot beverage are consistent in taste and flavor and are like the beverage manually prepared at that instant and location. The ready-to-drink cups of hot beverage dispensed by the assembly are customized to the consumer's preferences like “strong”, “light”, “with milk”, “without milk”, etc.” in accordance with the input given by selecting switch on the electronic control panel of the assembly. The assembly of the present invention, being fully automatic and time-efficient, is specifically, but without implying any limitation thereto, useful for meeting bulk demands in offices, restaurants, ceremonial functions, public meetings, etc.

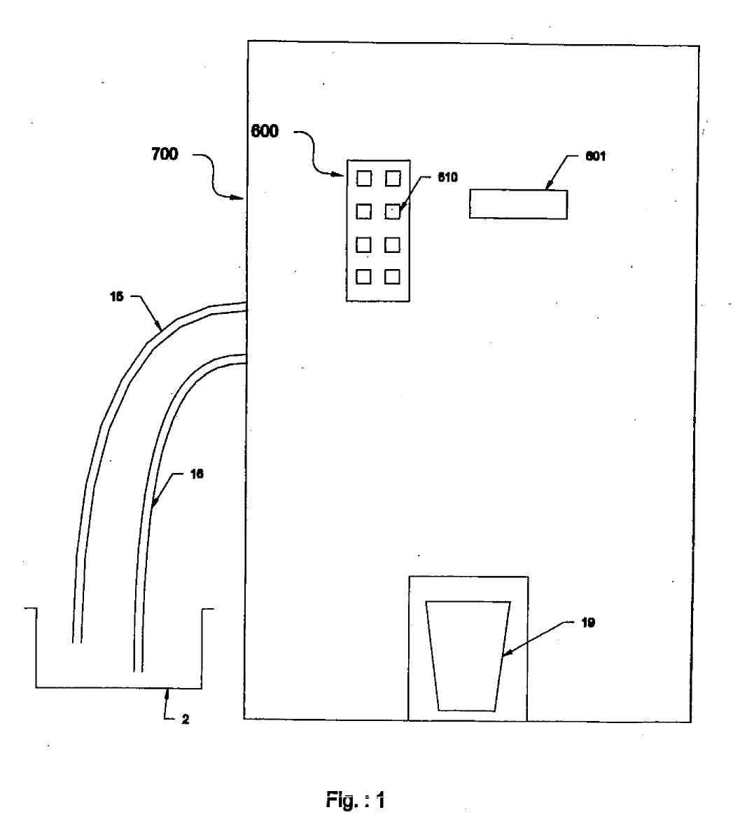

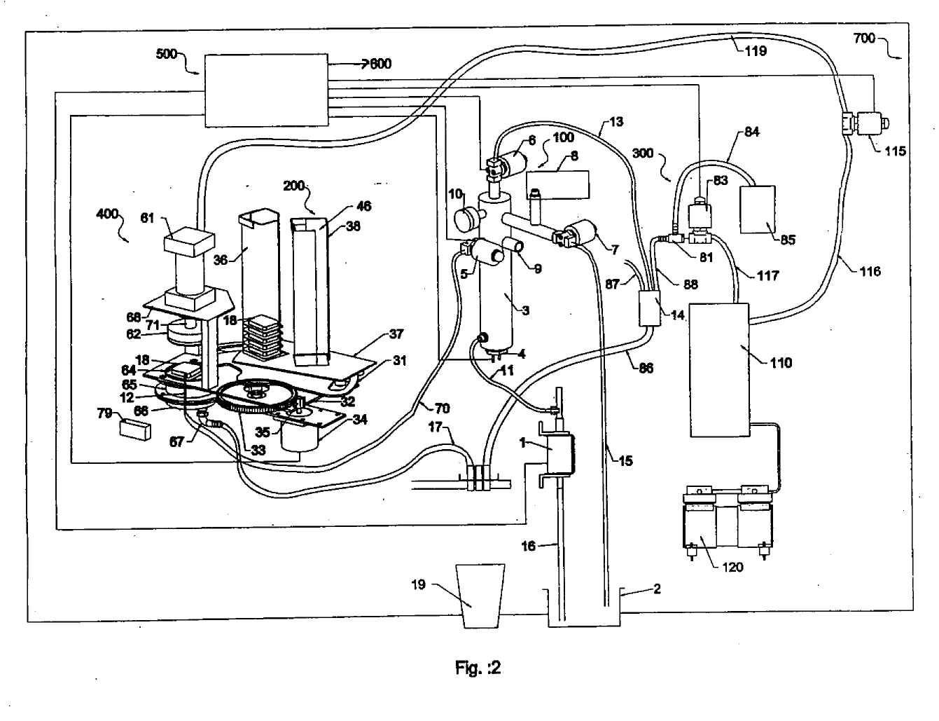

Referring to FIG. 1, the assembly of the present invention is housed in a housing (700), with its front side having a door hinged onto it. An electronic control panel (600) having a plurality of switches like (610), is fitted on to the said front door of the housing (700). The said switches (610) are internally connected by electric cables to an electronic processor (500) (FIG. 2) housed inside the housing (700). Each switch (610) corresponds to an option of a particular type of hot beverage selectable by the operator based on a consumer's preference, such as “strong”, “light”, “with milk”, “without milk”, etc. Depending upon the consumer's preference for the type of hot beverage desired by him, the operator or the consumer selects the corresponding switch (610) on the electronic control panel (600). The signal generated through this input command is conveyed to the electronic processor (500) (FIG. 2) through connecting electric cables. In accordance with this input command, the electronic processor (500) (FIG. 2) triggers the necessary electrical components in the individual sub-assemblies, resulting in the automatic dispensing of the customized hot beverage into a dispensing cup.

An electronic display panel (601) is provided on the front door of the housing (700). The electronic display panel (601) displays the current functional status of the assembly like “ready to vend”, “currently vending”, etc. A dispensing area is also provided in the front door of the housing (700) for placing the dispensing cup (19) so that there is direct flow of the brewed liquid from the brewer chamber (65) (FIG. 2) into this dispensing cup (19) through the dispensing tube (17) (FIG. 2) and also of the heated liquid milk from the milk-mixing chamber (14) (FIG. 2) (when milk is dosed) into this dispensing cup (19) through the dispensing tube (86) (FIG. 2).

A water reservoir (2) is preferably placed outside the housing (700). The water from the water reservoir (2) is pumped by a water pump (1) (FIG. 2) via a tube (16) and is fed to a sealed boiler tank (3) (FIG. 2) via the connecting tube (11) (FIG. 2). The upper end of the sealed boiler tank (3) (FIG. 2) is connected by tube (15) to water reservoir (2) through a pressure relief solenoid valve (7) (FIG. 2) which is controlled by pressure sensor (8) (FIG. 2).

Referring to (FIG. 2), the assembly of the present invention inside the said housing (700) includes water heating sub-assembly (100), a pod-conveyor sub-assembly (200), a milk input sub-assembly (300), a brewer sub-assembly (400) and an electronic processor (500). The said electronic processor (500) is connected by electric cables to the electronic control panel (600) (FIG. 1) fitted on the front door of the said housing (700) (FIG. 1). The electronic processor (500) receives signals from the electronic control panel (600) (FIG. 1) through the inter-connecting electric cables.

The assembly also includes an air-compressor (120), which compresses the air and pumps such compressed air into the connected compressed air storage tank (110), which is a hollow metallic cylinder. The compressed air storage tank (110) is connected to air solenoid valve (83) via connecting tube (117) as well as to air solenoid valve (115) via connecting tube (116). The said air solenoid valve (115) is further connected to pneumatic cylinder (61) in brewer sub-assembly (400) via connecting tube (119). The compressed air from the compressed air storage tank (110) is used to operate pneumatic cylinder (61) and venturi valve (81).

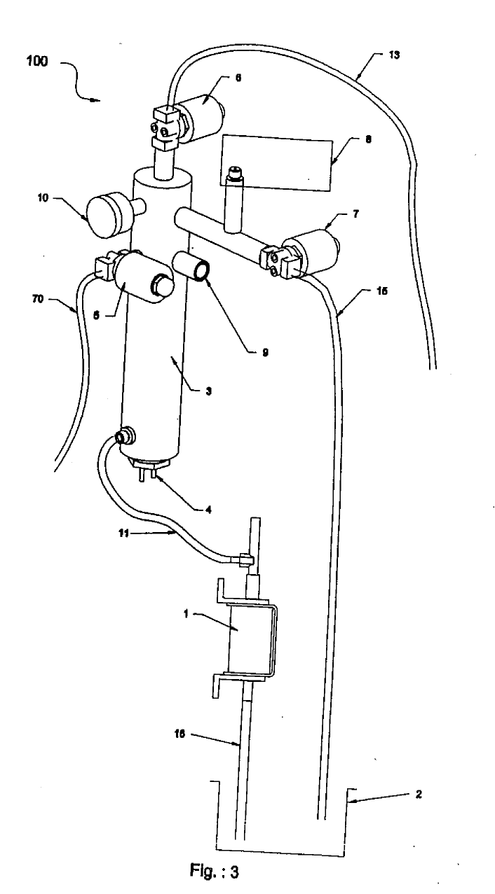

Referring to FIG. 3, the water heating sub-assembly (100) includes a water pump (1), which draws water from a water reservoir (2) through a tube (16) made of food grade material. The water is pumped by the said water pump (1) into a sealed boiler tank (3) through a connecting tube (11) made of food grade material. The water reservoir (2) is preferably placed outside the housing (700) (FIG. 1). The water in the sealed boiler tank (3) is heated by heating element (4), which heats the water to a pre-set temperature, controlled by the temperature sensor (9). The use of a sealed boiler tank (3) makes the assembly energy-efficient.

Generally, the water in the sealed boiler tank (3) is kept in the temperature range of 60 to 160 degrees Celsius, preferably in the temperature range of 90 to 140 degrees Celsius. The sealed boiler tank (3) maintains water at high temperature, without allowing escape of oxygen dissolved in the water, thereby further improving the quality of the brewed beverage, especially tea. The use of hot water at high temperature for brewing in the brewer sub-assembly (400) (FIG. 2) also enables quick extraction of the brew. An outlet solenoid valve (5) is fitted to the sealed boiler tank (3), which enables supply of hot water for brewing into the brewer sub-assembly (400) (FIG. 2) through connecting tube (70), which is made of food grade material. Another outlet solenoid valve (6) is provided on the sealed boiler tank (3), which enables supply of steam for heating milk in the milk-mixing chamber (14) (FIG. 2) through the connecting tube (13), which is made of food grade material.

The pressure in the sealed boiler tank (3) is sensed by the pressure sensor (8) and is generally kept in the range of 15 to 45 psi. When the pressure exceeds the set pressure, a pressure relief solenoid valve (7) provided on the upper side of the sealed boiler tank (3) is activated with the help of the pressure sensor (8), which releases the extra pressure from inside the sealed boiler tank (3) through the tube (15) which enables to maintain the pressure inside the sealed boiler tank (3) below the set maximum pressure. This protects the sealed boiler tank (3) against any possibility of excessive pressure buildup inside it. The sealed boiler tank (3) is also fitted with a pressure gauge (10) for visual monitoring of the pressure inside the sealed boiler tank (3).

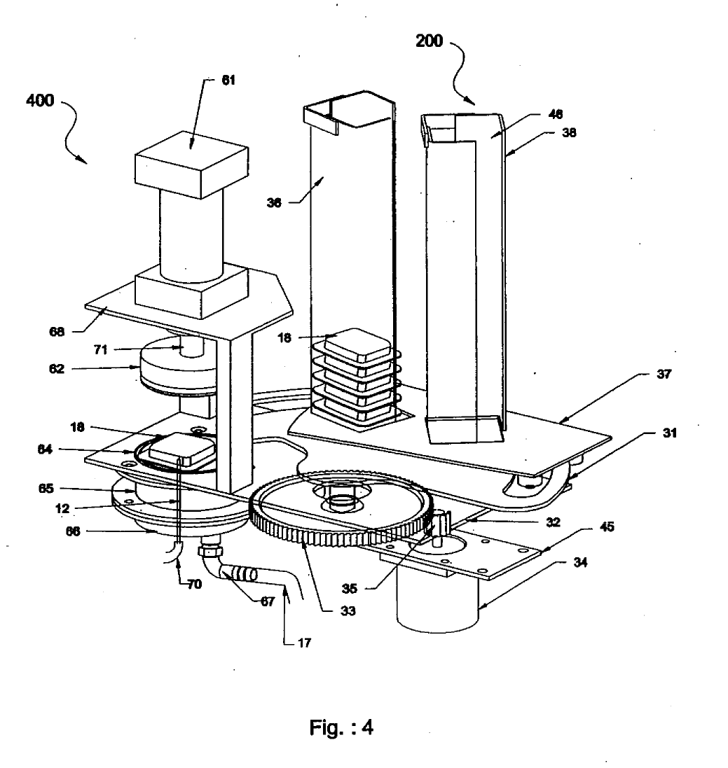

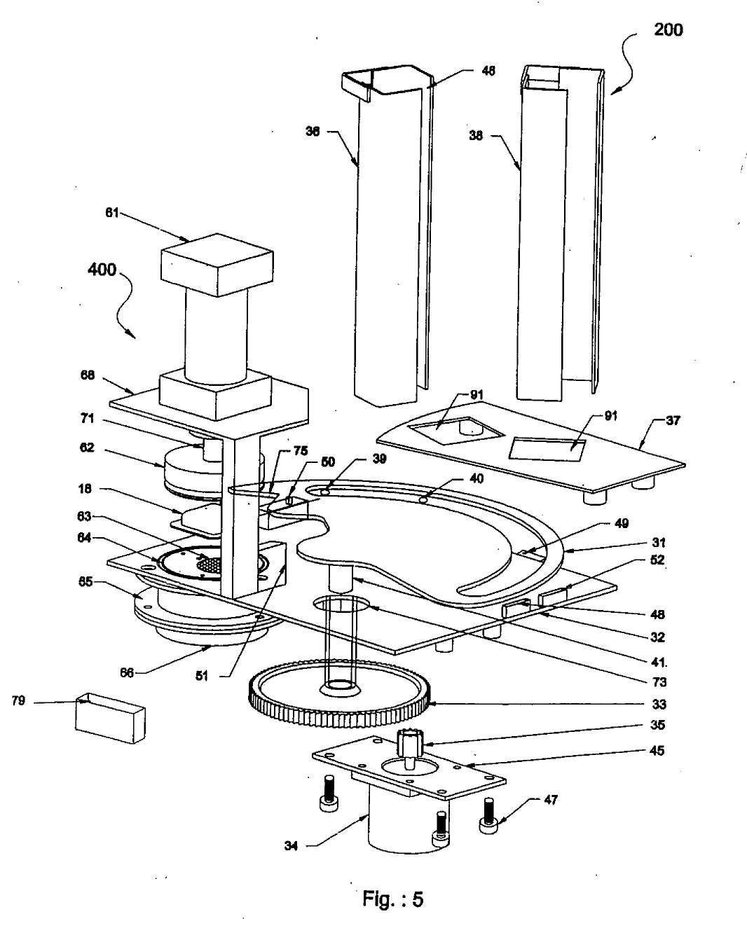

Referring to FIG. 4 and FIG. 5, the pod-conveyor sub-assembly (200) includes a novel pod-conveyor (31) having an integral shaft (41) from underneath around the middle portion of its front curvilinear contour. The pod-conveyor (31) is rotatable on the integral shaft (41) in clockwise and anti-clockwise direction in a substantially horizontal plane, within the space between a base plate (32) and chute supporting plate (37). The integral shaft (41) is fitted to the pusher gear (33) positioned underneath the base plate (32) through a bush (73) mounted on the base plate (32). The pusher gear (33) is engaged with the motor gear (35) of the pusher motor (34) so that when the motor gear (35) is rotated by the pusher motor (34), it results in the rotation of the pusher gear (33) in the opposite direction. When this happens, it also results in rotation of the pod-conveyor (31) in the same direction as the pusher gear (33).

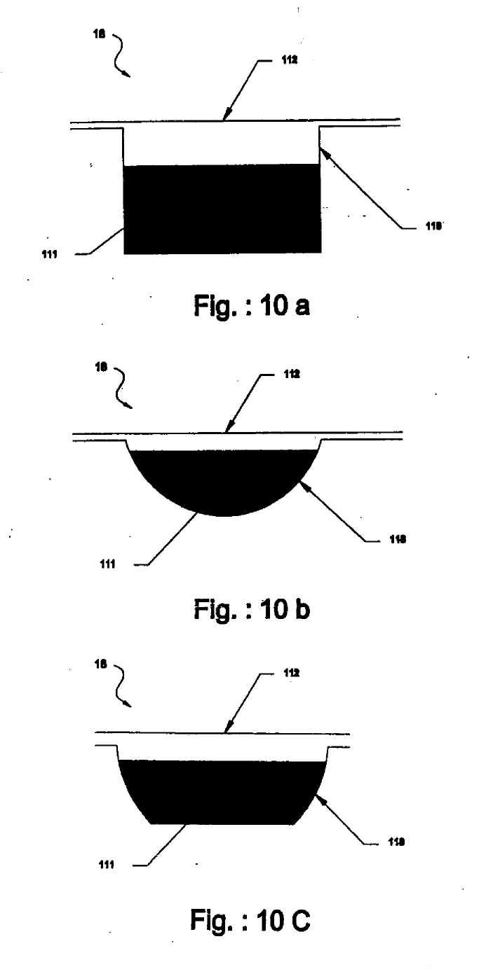

The single serving pods (18) containing the brewing material (111) (FIG. 10a, 10b, 10c) are stacked in inverted position in the plurality of static chutes like chute (36) and chute (38) which are vertical hollow tubes. These chutes are fitted over the upper surface of a chute supporting plate (37). The chutes (36, 38) extend vertically upwards from the apertures (91, 91) provided on the chute supporting plate (37). The apertures (91, 91) conform in dimension and shape to the internal dimensions and shape of the chutes (36, 38). Chutes (36, 38) have one or more vertical slots (46) extending from top to the bottom of chutes (36, 38) to facilitate loading and stacking of the pods (18) therein. These chutes (36, 38) are designed to stack therein up to 100 single serving pods (18) each, in an inverted position with porous membrane (112) (FIG. 10a, 10b, 10c) facing downwards. It is to be noted that the chutes (36, 38) may have different shapes conforming to the shape of pods (18), which may also vary in shape (like shown in FIG. 10(a), FIG. 10(b), FIG. 10(c)). For example, the chutes (36, 38) may have circular cross-section instead of square cross-section, when the pods (18) are circular in shape, instead of being square in shape. The single serving pods (18) can smoothly move downwards through chutes (36, 38) as well as through the aligned apertures (91, 91) from where these are conveyed and positioned by the pod-conveyor (31) into the brewer sub-assembly (400).

A sensor (39) is fixed below the base plate (32) and underneath the chute (36), which provides signal to the electronic processor (500) (FIG. 2) when this chute (36) is empty, i.e. no pods (18) are remaining therein. When the sensor (39) senses that chute (36) is empty, the sensor (39) sends a signal to the electronic processor (500) (FIG. 2), which in turn activates pusher motor (34) to cause pod-conveyor (31) to rotate in a clockwise direction to a position behind chute (38) till it activates limit switch (48) which sends a signal to the electronic processor (500) (FIG. 2) to stop further clockwise rotational movement of the pod conveyor (31) by de-activating pusher motor (34).

A sensor (40) is fixed below the base plate (32) and underneath the chute (38), which provides signal to the electronic processor (500) (FIG. 2) when this chute (38) is empty, i.e. no pods (18) are remaining therein. When the sensor (40) senses that chute (38) is empty, the sensor (40) sends a signal to the electronic processor (500) (FIG. 2), which in turn activates pusher motor (34) to cause pod-conveyor (31) to rotate in an anti-clockwise direction. This results in rotational movement of the inward contour (75) of the pod-conveyor (31) to a position behind chute (36) till it activates limit switch (52), which sends a signal to electronic processor (500) (FIG. 2), which in turn stops further rotational movement of pod-conveyor (31) by switching off the power supply to the pusher motor (34). Simultaneously, the electronic processor (500) (FIG. 2) also halts till refill of the empty chutes (36, 38) with fresh pods (18), of the brewing process in the brewer sub-assembly (400) by switching off power supply to the air solenoid valve (115) (FIG. 2) and also sends a signal to the electronic display panel (601) (FIG. 1) to provide message to the operator to refill chutes (36, 38) with pods (18). Thus sensor (40) prevents brewing within the assembly when chute (36) and chute (38) are both empty. The sensors (39, 40) increase the capability of the assembly to operate with larger number of pods (18) stacked in plurality of chutes like (36, 38) to meet bulk demands in short time.

It is to be noted that though drawings show an embodiment of the present invention having two chutes (36, 38) fitted to the chute supporting plate (37) over the dimensionally aligned apertures (91, 91), however, more number of such chutes (36, 38) conforming to the shape of pods (18) used, can be provided and fitted to the chute supporting plate (37) by suitably modifying the chute supporting plate (37), pod conveyor (31) and the associated components.

A pusher motor (34) is mounted on a motor plate (45) by suitable fixing means and the motor plate (45) is fixed underneath to the base plate (32) by fixing means such as four bolts (47, 47, 47, 47). The pod conveyor (31) has a curvilinear contour which enables its uninterrupted rotation in substantially horizontal plane in clockwise or anticlockwise direction within the space between the base plate (32) and the chute supporting plate (37). The forward end of the pod-conveyor (31) has an inward contour (75), which aligns with the external contour of the pod (18). Due to this, when this forward end of the pod-conveyor (31) comes in contact with the pod (18) during anti-clock wise rotation, it aligns with the external contour of the pod (18), holds the pod (18) firmly within its inward contour (75), and conveys the pod (18) from the chute (36 or 38) to the brewer sub-assembly (400), without any guide channel. The pod-conveyor (31) then precisely positions the pod (18) over the filter disc (63), which is placed on the filter disc holding plate (64) in the brewer sub-assembly (400). The precise positioning of the pod (18) in the brewer sub-assembly (400) is enabled by the limit switch (49) as hereinafter described.

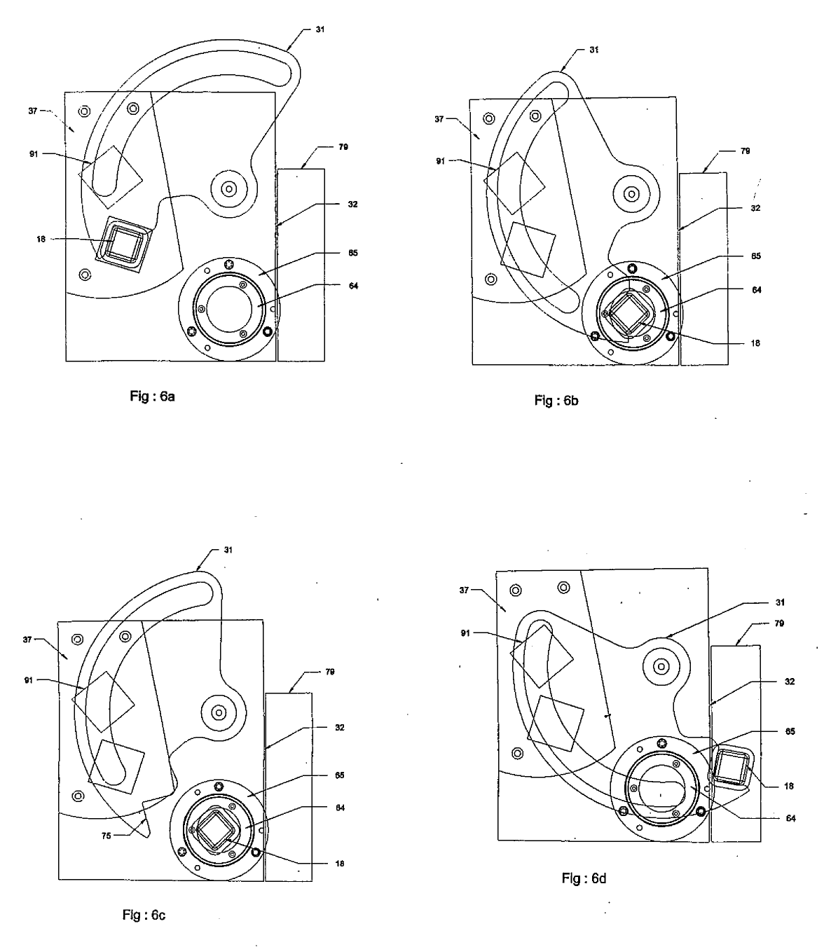

The pod-conveyor sub-assembly (200) includes different limit switches (48, 49, 50, 51, 52) which when activated, stop the clockwise or anti-clockwise rotational movement of the pod-conveyor (31) at specific positions by giving signal to electronic processor (500) (FIG. 2) which in turn switches off the power supply to the pusher motor (34). The limit switch (49) enables to stop the further anti-clockwise rotation of the pod-conveyor (31) after precise positioning of the pod (18) over the filter disc (63) in the brewer sub-assembly (400), as shown in FIG. 6(b). The limit switch (50) enables to stop the clockwise rotation of the pod-conveyor (31) and enables to hold the pod-conveyor (31) at a position between the chute (36) and the brewer sub-assembly (400) till the brewing of the brewing material (111) (FIG. 10a, 10b, 10c) contained in the pod (18), is completed, as shown in FIG. 6(c). The limit switch (51) enables to stop the second anti-clock wise rotation of the pod-conveyor (31) after the used pod (18) has been disposed off by the pod-conveyor (31) (as shown in FIG. 6(d)) to a disposal bin (79) placed by the side of the brewer sub-assembly (400). The limit switch (52) enables to stop the second clockwise rotation of the pod-conveyor (31) when the inward contour (75) of the pod-conveyor (31) reaches behind chute (36) (as shown in FIG. 6(a)). The limit switch (48) enables to stop the clock-wise rotation of the pod-conveyor (31) at a position behind chute (38) when chute (36) is sensed to be empty by the sensor (39). When sensor (40) detects chute (38) also to be empty, limit switch (52) is activated which enables to stop the anti-clockwise rotation of the pod-conveyor (31) after it reaches back to its rest/start position behind chute (36), as shown in FIG. 6(a).

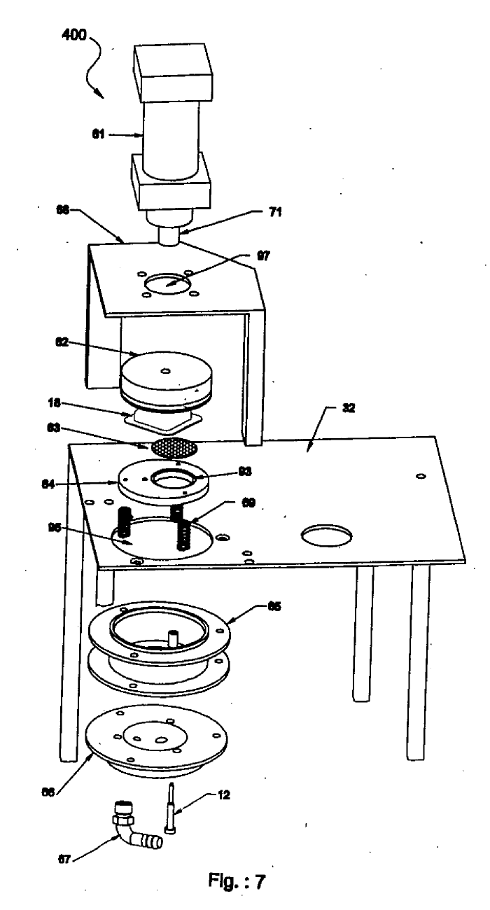

Referring to FIG. 7, the brewer sub-assembly (400), includes a drive means to move brewer plunger (62) such as pneumatic cylinder (61) with piston rod (71) mounted on a supporting plate (68) with said piston rod (71) being fitted through the dimensionally aligned circular aperture (97) on the said supporting plate (68). A brewer plunger (62) is fitted to the said piston rod (71) of the said pneumatic cylinder (61) from underneath the said supporting plate (68). The pneumatic cylinder (61) thus being over the supporting plate (68) whereas brewer plunger (62) being underneath the supporting plate (68).Alternate drive means to move brewer plunger (62) downwards could be hydraulic cylinder or electro-mechanical linear actuator.

A perforated non-corrosive food-grade metallic filter disc (63) is placed over a filter disc holding plate (64), which rests on three springs (69) placed between the filter disc holding plate (64) and the brewer chamber (65). The filter disc holding plate (64) is placed, through a dimensionally aligned aperture (95) in the base plate (32). The filter disc (63) has very fine pores up to 250 microns, which prevent miniscule particles of the brewing material (111) (FIG. 10a, 10b, 10c) from passing through and entering into the dispensing cup (19) (FIG. 2).

The brewer chamber (65) is fixed below the base plate (32) with its top open end aligned to the aperture (95). The brewer chamber (65), in fixed position, is also aligned to the brewer plunger (62) such that during the upward and downward movement of the brewer plunger (62) imparted to it by the piston rod (71), the brewer plunger (62) is able to move the filter disc holding plate (64) along with filter disc (63) and pod (18) placed over it, up and down into the body of the brewer chamber (65) in a smooth tight-fitting and uninterrupted manner. A brewer base (66) is detachably fixed to the bottom of the brewer chamber (65) by a fixing means. An injection nozzle (12) is detachably and conveniently mounted to the said brewer base (66) by means of a flange. Due to this, at any point of time, the injection nozzle (12) can be easily detached for the purposes of cleaning or maintenance. A liquor outlet port (67) for the brewed beverage is provided at the brewer base (66), which lets the brewed beverage to flow out of the brewer chamber (65) into the dispensing cup (19) (FIG. 2) via the dispensing tube (17) (FIG. 2), which is made of food grade material.

The pneumatic cylinder (61) is connected via connecting tube (119) (FIG. 2) to air solenoid valve (115) (FIG. 2), which in turn is connected via connecting tube (116) (FIG. 2) to the compressed air storage tank (110) (FIG. 2). The pneumatic cylinder (61) is operated using compressed air drawn from the said compressed air storage tank (110) (FIG. 2), the flow of which is controlled by the air solenoid valve (115) (FIG. 2). This arrangement enables speedy up and down movements of the brewer plunger (62) into the brewer chamber (65) during brewing process which significantly reduces the cycle time per brew.

The injection nozzle (12) is a tube, preferably made of non-corrosive food grade metallic material such as stainless steel, which is connected to the sealed boiler tank (3) (FIG. 2) through the outlet solenoid valve (5) (FIG. 2) via connecting tube (70) (FIG. 2). The said injection nozzle (12) has a conical tip, which is capable of puncturing the porous membrane (112) (FIG. 10a, 10b, 10c) sealing the contents of the pod (18), when the pod (18) is pressed against the injection nozzle (12) by the brewer plunger (62) during the downward motion imparted to it by the piston rod (71). Once the porous membrane (112) (FIG. 10a, 10b, 10c) of the pod (18) is thus punctured, the conical tip of the injection nozzle (12) directs the hot pressurized water flowing through its interior, from the sealed boiler tank (3) (FIG. 2), into the interior of the pod (18), thereby brewing the brewing material (111) (FIG. 10a, 10b, 10c) contained inside the pod (18). The conical tip of the injection nozzle (12) penetrates up to the top end of the pod (18) kept in inverted position, which results in the splashing back of hot pressurized water inside the pod (18) causing uniform spread of hot pressurized water in the interior of the pod (18), thereby thoroughly brewing every minute particle of the brewing material (111) (FIG. 10a, 10b, 10c) contained within the pod (18).

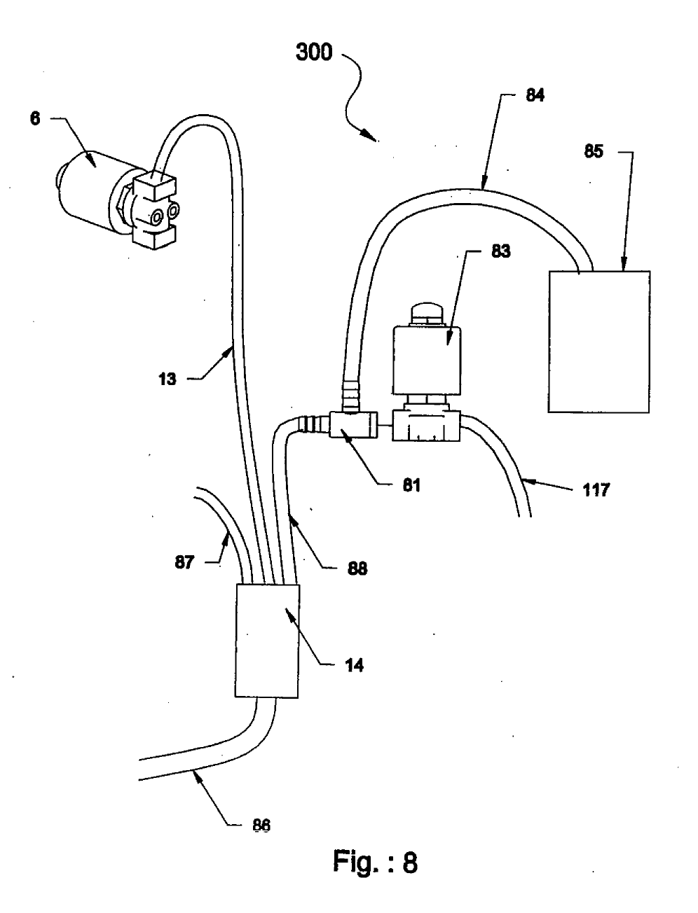

Referring to FIG. 8, the milk input sub-assembly (300) is designed to accept liquid milk from a liquid milk container (85). It includes a venturi valve (81) having suction tube (84), made of food grade material, which is inserted into the liquid milk container (85). The venturi valve (81) is also connected to a milk-mixing chamber (14) by a connecting tube (88) made of food grade material. The outlet solenoid valve (6) for steam, which has its one end connected to the sealed boiler tank (3) (FIG. 2), has its other end connected to milk mixing chamber (14) via connecting tube (13), made of food grade material. The air solenoid valve (83) is connected to compressed air storage tank (110) (FIG. 2) via a connecting tube (117) made of food grade material. The dispensing tube (86) made of food grade material conveys the heated milk from the milk mixing chamber (14) into the dispensing cup (19) (FIG. 2).

When the air solenoid valve (83) opens, it allows compressed air to flow from the compressed air storage tank (110) (FIG. 2) into the venturi valve (81), thereby creating a vacuum inside the venturi valve (81), due to which liquid milk is sucked from the liquid milk container (85) via the suction tube (84) and is fed into the milk mixing chamber (14) through the connecting tube (88). At the same time, steam is injected into the milk-mixing chamber (14) from the sealed boiler tank (3) (FIG. 2) through the outlet solenoid valve (6) via connecting tube (13). This steam heats the milk in the milk-mixing chamber (14) and the milk thus heated is dispensed through the dispensing tube (86) into the dispensing cup (19) (FIG. 2). An exhaust pipe (87) is provided through the top of the milk-mixing chamber (14) to release the compressed air coming from the air solenoid valve (83).

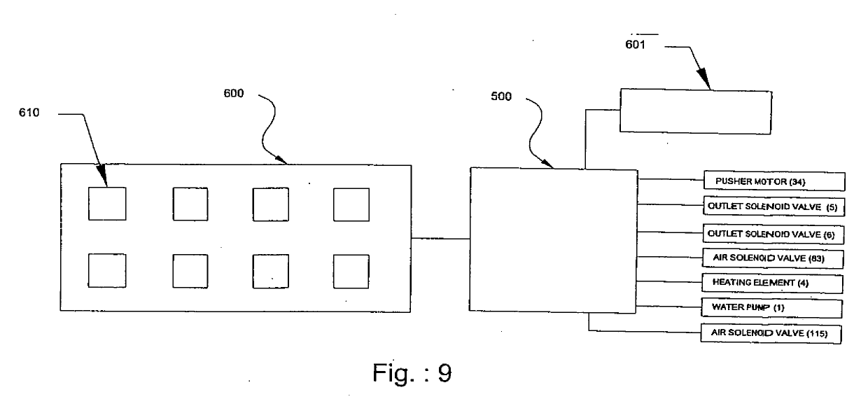

Referring to FIG. 9, the electronic processor (500) is connected by electric cables to the electronic control panel (600) provided on the front door of the housing (700) (FIG. 1). The electronic control panel (600) takes input from the operator of the assembly in regard to the preference of the consumer for the type of hot beverage desired by him, by operating one of the switches like (610) on the electronic control panel (600). The electronic control panel (600) sends the signal to the electronic processor (500) by means of connecting electric cables. The electronic processor (500) in turn is connected by electric cables to the electrical components of the other sub-assemblies. The electronic processor (500) controls the operations of pusher motor (34), outlet solenoid valve (5) for hot pressurized water, outlet solenoid valve (6) for steam, air solenoid valve (83), heating element (4), water pump (1) and air solenoid valve (115). Based on the selection on the electronic control panel (600), the electronic processor (500) triggers the required electrical components of the other sub-assemblies in the required sequence, and the assembly automatically brews and dispenses the desired type of hot beverage into the dispensing cup (19) (FIG. 1).

Referring to FIGS. 10a, 10b, 10c, the single serving pod (18) is a receptacle (118) made up of substantially rigid food grade material, containing the brewing material (111) for the desired beverage. The open side of the receptacle (118) is covered and sealed with a food grade porous membrane (112) like filter paper. The sealing of the brewing material (111) contained in pod (18) by a food grade porous membrane (112) keeps the brewing material (111) inside the pod (18) in a hygienic manner. The brewing material (111) in the pod (18) is of predetermined quantity, up to 20 grams, preferably in the range of 0.1 to 12 grams, depending upon the nature of the brewing material (111).

It is to be noted that the pod (18) may have various embodiments as shown in FIG. 10 (a), FIG. 10 (b) and FIG. 10 (c). The contents of the pod (18) may be sealed by any porous membrane (112) material which could be punctured by the conical tip of the injection nozzle (12) (FIG. 7), when pod (18) is pressed against it during the downward motion of the brewer plunger (62) (FIG. 7) imparted to it by piston rod (71) (FIG. 7). The chutes (36, 38) (FIG. 2) also need to be of the shape and dimensions conforming to the shape and dimensions of the pods (18) so that the pods (18) are stackable therein in the inverted position, with one pod (18) stacked over the other and with the porous membrane (112) facing downwards.

### Working of the Assembly

Prior to beginning of operation of the assembly, the operator loads pods (18) into the chutes (36, 38) with the porous membrane (112) of the pod (18) facing downwards and one pod (18) stacked over the other. The vertical slot (46) provided in chute (36) and in chute (38) helps the operator to load and stack the pods (18) in correct alignment within the chutes (36, 38). During this pod loading operation, the pod conveyor (31) is positioned at its rest or start position with its inward contour (75) behind chute (36) as shown in FIG. 6(a). During the loading of chute (36) with pods (18), the lowermost pod (18) contained therein rests on base plate (32) directly in front of and in alignment with the inward contour (75) of pod conveyor (31). During the loading of chute (38) with pods (18), the lowermost pod (18) contained therein rests over the upper surface of the pod-conveyor (31).

In the operation of the assembly, the operator makes the selection of switch (610) on electronic control panel (600) as per the consumer's preference for the type of beverage and the input signal through the selected switch is conveyed by electric cables to the electronic processor (500). The electronic processor (500) triggers the electrical components of other sub-assemblies in a definite sequence, according to the selection made. For example: If the selection is made for “strong tea with milk”, then the electronic processor (500) sends a signal to the sensor (39) to first check for the stock of pods (18) in the chute (36). In case, chute (36) is not empty i.e. pod (18) is available in this chute (36), the electronic processor (500) first sends a signal to activate the pusher motor (34) which in turn rotates the pod-conveyor (31) in an anti-clockwise direction till the pod (18) is conveyed from the chute (36) and is precisely positioned over filter disc (63) as shown in FIG. 6(b). At this precise instant, limit switch (49) gets activated and sends a signal to the electronic processor (500) which in turn switches off power supply to the pusher motor (34), thereby stopping further anti-clockwise rotation of the pod-conveyor (31). Then, the electronic processor (500) gives signal to pusher motor (34) which activates clockwise rotation of the pod-conveyor (31) so as to move the pod-conveyor (31) away from brewer plunger (62) prior to when the brewer plunger (62) comes down into the brewer chamber (65) for brewing. The limit switch (50) is activated when the inward contour (75) of the pod-conveyor (31) reaches a position between chute (36) and the brewer sub-assembly (400) as shown in FIG. 6(c), which then sends a signal to the electronic processor (500) which in turn switches off the power supply to the pusher motor (34) thereby stopping this clockwise rotation of the pod-conveyor (31).

On the other hand, if the sensor (39) returns a ‘no stock’ signal to the electronic processor (500), the electronic processor (500) sends a signal to activate the pusher motor (34), which in turn rotates the pod-conveyor (31) in a clock-wise direction till the inward contour (75) of the pod-conveyor (31) reaches a position behind chute (38). At this position of the pod-conveyor (31), the limit switch (48) is activated which sends a signal to the electronic processor (500) which in turn stops the rotational movement of the pusher motor (34), thereby stopping the pod-conveyor (31) at this position. When this happens, and if pod (18) is available within chute (38), the pod (18) contained within chute (38) which was hitherto held in position within chute (38) resting over the upper surface of the pod conveyor (31), drops onto the base plate (32) directly in front of and in alignment with the inward contour (75) of pod conveyor (31). At this position of pod conveyor (31), the electronic processor (500) sends a signal to sensor (40) to check for stock of pods (18) in chute (38). If sensor (40) senses presence of pods (18) in chute (38), with the lowermost pod (18) in the said chute (38) resting over the base plate (32) directly in front of and in alignment with the inward contour (75) of pod conveyor (31), sensor (40) sends a signal to the electronic processor (500) which activates the pusher motor (34) which in turn rotates the pod-conveyor (31) in an anti-clockwise direction till pod (18) is conveyed from its position beneath the chute (38) and is precisely positioned over the filter disc (63) in the brewer sub-assembly (400) as shown in FIG. 6(b). At this position, limit switch (49) sends a signal to the electronic processor (500), which in turn stops further rotational movement of the pod-conveyor (31). Then the electronic processor (500) gives signal to pusher motor (34) which activates clockwise rotation of the pod conveyor (31) so as to move the pod conveyor (31) away from brewer plunger (62) prior to when the brewer plunger (62) comes down into the brewer chamber (65) for brewing. When the inward contour (75) of the pod conveyor (31) precisely reaches a position between chute (36) and the brewer sub-assembly (400) as shown in FIG. 6 (c), the limit switch (50) sends a signal to the electronic processor (500) which in turn switches off the power supply to the pusher motor (34) thereby stopping further clockwise rotation of the pod conveyor (31).

If the sensor (40) senses that chute (38) is empty, the sensor (40) sends a signal to the electronic processor (500), which in turn activates the pusher motor (34) to cause pod-conveyor (31) to rotate in an anti-clockwise direction. This results in rotational movement of the inward contour (75) of the pod-conveyor (31) to a position behind chute (36), as shown in FIG. 6(a) till it activates limit switch (52), which sends a signal to the electronic processor (500) which in turn stops further rotational movement of pod conveyor (31). Simultaneously, the electronic processor (500) also halts till refill of the chutes (36, 38) with pods (18), of the brewing process in the brewer sub-assembly (400) by switching off power supply to the air solenoid valve (115) and also sends a signal to the electronic display panel (601) providing message to the operator to refill chutes (36, 38) with pods (18). Thus sensor (40) prevents brewing within the assembly when chute (36) and chute (38) are both empty.

On automatic conveying of the pod (18) from either of the chutes (36, 38) and after positioning of the pod over the filter disc (63) within the brewer sub-assembly (400), the electronic processor (500) signals to activate the air solenoid valve (115). This allows the compressed air from the compressed air storage tank (110) to pass through the connecting tube (116) and also through the connecting tube (119) into the pneumatic cylinder (61). The compressed air, which thus enters into the pneumatic cylinder (61), pushes the piston rod (71) downwards which in turn moves the brewer plunger (62) down into the brewer chamber (65). The single serving pod (18) which is directly below the brewer plunger (62) and over the filter disc holding plate (64), thereby moves downward into the brewer chamber (65) along with the brewer plunger (62) which results in pressing of the porous membrane (112) of the inverted pod (18) against the conical tip of the injection nozzle (12) resulting in the puncturing of the porous membrane (112) of the pod (18). After this, the electronic processor (500) activates the outlet solenoid valve (5), which enables the hot pressurized water from the sealed boiler tank (3) to pass through the connecting tube (70) and enter the pod (18) through the interior of the injection nozzle (12). The conical tip of the injection nozzle (12) penetrates right up to the top of the inverted pod (18) thereby enabling splashing and uniform spread of hot pressurized water within the pod (18) through the injection nozzle (12). The hot pressurized water thus injected into the pod (18) thoroughly brews every minute particle of the brewing material (111) contained in the pod (18) and the brewed hot beverage is filtered by the porous membrane (112) of the pod (18) and filter disc (63), which then flows into the dispensing cup (19) through the dispensing tube (17).

After the specified time required for brewing is completed, the electronic processor (500) sends a signal to the outlet solenoid valve (5) to close, thereby shutting off the supply of hot pressurized water into the injection nozzle (12). The electronic processor (500) then sends a signal to air solenoid valve (83) to open, which allows compressed air from compressed air storage tank (110) to enter the venturi valve (81) which in turn sucks up liquid milk from the liquid milk container (85) through suction tube (84) and feeds it to the milk-mixing chamber (14), through connecting tube (88). At the same time the electronic processor (500) sends a signal to open outlet solenoid valve (6) for steam fitted to the sealed boiler tank (3), which allows steam to move into the milk-mixing chamber (14) through connecting tube (13), which heats up the milk in the milk-mixing chamber (14). The milk thus heated in the milk-mixing chamber (14) gets dispensed through the dispensing tube (86) into the dispensing cup (19). After the specified time for addition of milk into the dispensing cup (19), the electronic processor (500) concurrently deactivates the outlet solenoid valve (6), thereby shutting off the supply of steam from sealed boiler tank (3) to the milk-mixing chamber (14), as well as shutting off air solenoid valve (83) which in turn stops the flow of milk from the liquid milk container (85) via venturi valve (81) into the milk-mixing chamber (14). The addition of heated milk into the dispensing cup (19) is thus completed.

The electronic processor (500) then deactivates the air solenoid valve (115), which allows the compressed air inside the pneumatic cylinder (61) to be released, thereby moving the piston rod (71) along with the brewer plunger (62) upward. Concurrent to this upward movement of the brewer plunger (62), the filter disc holding plate (64) along with the filter disc (63) and the used pod (18) lying over the said filter disc (63), move upwards simultaneously until the filter disc holding plate (64) returns to its initial rest position, prior to the brewing process, leaving the used pod (18) on the filter disc (63). The electronic processor (500) then activates the pusher motor (34) so as to cause rotational movement of the pod-conveyor (31) in an anti-clockwise direction pushing the used pod (18) from above the filter disc (63) towards the disposal bin (79) placed adjacent to the brewer sub-assembly (400). At the precise position of the inward contour (75) of pod-conveyor (31) when the used pod (18) falls into the disposal bin (79) (as shown in FIG. 6(d)), the limit switch (51) is activated and sends a signal to electronic processor (500) which in turn stops further anti-clockwise rotation of pod-conveyor (31) by switching off power supply to pusher motor (34). After this, the electronic processor (500) activates the pusher motor (34) so as to cause rotational movement of the pod-conveyor (31) in a clockwise direction. This clockwise rotational movement of the pod-conveyor (31) is stopped by the limit switch (52) at the instant when the inward contour (75) of the pod-conveyor (31) reaches its rest or start position behind the chute (36) as shown in FIG. 6(a).

The assembly for automatic fresh brewing of hot beverage and dispensing thereof assembly of the present invention is susceptible to modifications, adaptations and equivalent changes by those skilled in the art. The principles and functional features of different components and sub-assemblies as taught by the present invention can be employed by those skilled in the art in numerous variant embodiments by making such adaptations, modifications and changes. Such embodiments are intended to be within the scope of the present invention, which is further set forth under the following claims:

1. An assembly for automatic fresh brewing of hot beverage and dispensing thereof wherein the brewing, infusible or other material (111) is contained in single serving pods (18) stacked in inverted position in plurality of static and vertically extending chutes (36, 38) and wherein said single serving pods (18) are conveyed to the brewer sub-assembly (400) by the rotational movement of a pod-conveyor (31) on an integral shaft (41) and wherein the said assembly comprises:
(a) a water heating sub-assembly (100) which includes:
a sealed boiler tank (3) provided with a heating element (4), outlet solenoid valve (5) for hot water, outlet solenoid valve (6) for steam, a pressure relief solenoid valve (7), a pressure sensor (8), a temperature sensor (9), a pressure gauge (10), wherein the temperature of hot water in the said sealed boiler tank (3) is in the range of 60 to 160 degrees Celsius; and
a water pump (1) drawing water from a water reservoir (2) through a tube (16) and feeding water to the said sealed boiler tank (3) through a connecting tube (11);
(b) a pod-conveyor sub-assembly (200) which includes:
a pod-conveyor (31) rotatable on an integral shaft (41) in a clockwise and anti-clockwise direction within the space between a base plate (32) and a chute supporting plate (37), the said pod-conveyor (31) having an inward contour (75) at its forward end which aligns with the external contour of the pod (18) and the said chute supporting plate (37) being placed above the said base plate (32) and spaced apart thereto;
a pusher gear (33) provided underneath the said base plate (32) and fitted on to the said integral shaft (41) through an aligned bush (73) on the said base plate (32);
a pusher motor (34) provided with motor gear (35) which is engaged with the said pusher gear (33), the said pusher motor (34) being fixed underneath a motor plate (45) which is fixed underneath the said base plate (32) by a fixing means such as four bolts (47, 47, 47, 47);
chutes like (36, 38) fitted on chute supporting plate (37) over apertures (91, 91) which are dimensionally aligned with chutes (36, 38) as well as single serving pods (18);
a sensor (39) fixed underneath base plate (32) and beneath chute (36) which is capable of sending signal to the electronic processor (500) to cause pod conveyor (31) to move to a position behind chute (38) when it detects the said chute to be empty,;
a sensor (40) fixed underneath base plate (32) and beneath chute (38) which is capable of sending signal to the electronic processor (500) when it detects the said chute (38) to be empty; the electronic processor (500) in turn causing pod-conveyor (31) to move to a position behind chute (36) and concurrently causing halting of brewing process in the brewer sub-assembly (400) till refill of the empty chutes (36, 38) with fresh pods (18), and also sending signal to the electronic display panel (601) providing message to the operator to refill the empty chutes (36,38) with fresh pods (18); and
limit switches (48, 49, 50, 51, 52) which when activated are capable of sending signal to the electronic processor (500) to cut off the power supply to the pusher motor (34) when pod-conveyor (31) is at specific positions during rotational clock-wise or anti-clockwise movements wherein limit switch (49) becomes activated when the pod-conveyor (31) is precisely positioned in the brewer sub-assembly (400), limit switch (50) becomes activated when the pod-conveyor (31) is positioned between chute (36) and brewer sub-assembly (400) while brewing is in progress in the brewer chamber (65), limit switch (51) becomes activated when the used pod (18) has been pushed into a disposal bin (79), limit switch (52) becomes activated when the pod-conveyor (31) reaches back to its rest/start position, limit switch (48) becomes activated when the sensor (39) senses chute (36) to be empty and the pod conveyor (31) is positioned behind chute (38); and limit switch (52) is activated again when sensor (40) detects chute (38) also to be empty and pod conveyor(31) reaches back to its rest/start position behind chute (36);
(c) a milk input sub-assembly (300) which includes:
a venturi valve (81) connected to a liquid milk container (85) by a suction tube (84),
air solenoid valve (83) connected at one end to said venturi valve (81) and at the other end to the compressed air storage tank (110) by connecting tube (117); and
a milk-mixing chamber (14) provided with a connecting tube (88) connecting to said venturi valve (81), a connecting tube (13) connecting to outlet solenoid valve (6), a dispensing tube (86) and air release exhaust pipe (87).
(d) a brewer sub-assembly (400) which includes:
a pneumatic cylinder (61) mounted on a supporting plate (68);
a brewer plunger (62) fitted to the piston rod (71) of the said pneumatic cylinder (61) underneath the said supporting plate (68), the said piston rod (71) being fitted through a dimensionally aligned circular aperture (97) in the said supporting plate (68);
brewer chamber (65);
a filter disc holding plate (64) mounted on the springs (69) through a dimensionally aligned aperture (95) in a base plate (32) and capable of uninterrupted movement up and down into the body of the said brewer chamber (65);
a filter disc (63) having fine pores, which is dimensionally aligned and placed over aperture (93) in the said filter disc holding plate (64);
a brewer base (66) having brewed liquor outlet port (67); and
an injection nozzle (12) detachably mounted on the said brewer base (66) by means of a flange wherein hot pressurized water from the said sealed boiler tank (3) traverses through the interior of the said injection nozzle (12) on opening of the said hot water solenoid valve (5) via the connecting tube (70), wherein the said injection nozzle (12) protrudes into the said brewer chamber (65) through the said brewer base (66) in such a way that when the said brewer plunger (62) activated by the pneumatic cylinder (61) via piston rod (71) moves the pod (18) kept on the said filter disc (63) down into the body of the said brewer chamber (65), the conical tip of the said injection nozzle (12) is capable of puncturing the said porous membrane (112) of the said pod (18) and injecting the hot pressurized water into the interior of the pod (18);
(e) an electronic processor (500) connected to electronic control panel (600), electronic display panel (601), pusher motor (34), outlet solenoid valves (5, 6), air solenoid valves (83, 115), water heating element (4), and water pump (1);
(f) a housing (700) to house the sub-assemblies at (a) to (e) above;
(g) an electronic control panel (600) mounted on the front door of the said housing (700) having plurality of switches like (610) and connected to the said electronic processor (500) by electric cables;
(h) an electronic display panel (601) mounted on the front door of the said housing (700) and connected to the said electronic processor (500) by electric cables;
(i) a water reservoir (2);
(j) a single serving pod (18) comprising a receptacle (118) containing brewing material (111) up to 20 grams which is covered and sealed with a food grade porous membrane (112); and
(k) an air compressor (120) pumping compressed air to compressed air storage tank (110) which is connected to air solenoid valve (83) by connecting tube (117) and to air solenoid valve (115) by connecting tube (116) and the said air solenoid valve (115) is further connected to pneumatic cylinder (61) by connecting tube (119) and wherein the brewer plunger (62) fitted to the piston rod (71) of the pneumatic cylinder (61) is operable up and down in the brewer chamber (65) by means of compressed air.

2. An assembly as claimed in claim 1 wherein the sealed boiler tank (3) is completely sealed without any opening to the external atmosphere.

3. An assembly as claimed in claim 1 wherein the temperature of the water in the sealed boiler tank (3) is maintained in the range of 90 to 140 degrees Celsius.

4. An assembly as claimed in claim 1 wherein the brewing of the brewing material (111) contained in the single serving pod (18) and automatic dispensing thereof is completed in the short time in the range of 10 to 20 seconds.

5. An assembly as claimed in claim 1 wherein the said single serving pod (18) is made up of food grade plastic material

6. An assembly as claimed in claim 1 wherein the injection nozzle (12) has an outer diameter of 4 mm.

7. An assembly as claimed in claim 1 wherein the said single serving pod (18) contains brewing material (111) of quantity in the range of 0.1 to 12 grams depending upon the nature of the brewing material (111).

8. An assembly as claimed in claim 1 wherein the shape and outer periphery of pod (18) conform to the shape and inner periphery of the chutes (36, 38).

9. An assembly as claimed in claim 1 wherein the said chutes (36, 38) can stack up to 100 pods (18) each, placed in inverted position, with porous membrane (112) facing downwards.

10. An assembly as claimed in claim 1 wherein the brewer sub-assembly (400) uses a pneumatic cylinder (61) to press down the brewer plunger (62) fitted to the piston rod (71) of the said pneumatic cylinder (61).

11. An assembly as claimed in claim 1 wherein the chutes (36, 38) have at least one vertical slot (46), which extends from the top to the bottom of each chute (36, 38).

12. An assembly as claimed in claim 1 wherein the said injection nozzle (12) is made of food grade non-corrosive material like stainless steel.

13. An assembly as claimed in claim 1 wherein the conical tip of the said injection nozzle (12) is capable of penetrating up to the top end of the pod (18) which is kept in an inverted position, with the porous membrane (112) facing downward.

14. An assembly as claimed in claim 1 wherein the said filter disc (63) is made of food grade non-corrosive material like stainless steel.

15. An assembly as claimed in claim 1 wherein the said filter disc (63) has fine pores of up to 250 microns each.

16. An assembly as claimed in claim 1 wherein an electronic display panel (601) is provided on the front door of the housing (700).

17. An assembly as claimed in claim 1 wherein the brewing, infusible or other material (111) that may be placed in the single serving pod (18) includes, without implying any limitation thereto, materials such as tea, coffee, materials of plant origin such as floral pieces like Jasmine flowers, vegetable pieces like carrots and onions, materials of animal origin such as honey or any other suitable beverage powder or material that can be used in the single serving pod (18).

18. An assembly as claimed in claim 1 wherein the brewed hot beverage is passed through two means for filtration purposes including porous membrane (112) and filter disc (63).

19. An assembly as claimed in claim 1 wherein the brewer sub-assembly is substantially airtight during brewing.

20. An assembly as claimed in claim 1 wherein the pressure of hot water inside the sealed boiler tank is in the range of 15 to 45 psi.

21. An assembly for automatic fresh brewing of hot beverage and dispensing thereof, as substantially herein described and illustrated with accompanying drawings.
